(19) United States
(12) Patent Application Publication
(10) Pub. No.: US 2025/0133077 A1
(43) Pub. Date: Apr. 24, 2025

(54) SYSTEMS AND METHODS FOR DYNAMIC, POWER-EFFICIENCY-BASED CRYPTOGRAPHIC PROTOCOL NEGOTIATION WITH INTERNET OF THINGS (IOT) DEVICES

(71) Applicant: ASSA ABLOY AB, Stockholm (SE)

(72) Inventor: Varadarajan Thulasirajan, Chennai (IN)

(21) Appl. No.: 18/577,360

(22) PCT Filed: Jul. 8, 2022
(86) PCT No.: PCT/EP2022/069051

§ 371 Date: Jan. 8, 2024

(30) Foreign Application Priority Data
Jul. 9, 2021 (IN) 202141030991

(51) Int. Cl. H04L 9/40

(52) U.S. Cl. CPC H04L 63/0876; H04L 63/205

(57) ABSTRACT

Disclosed herein are systems and methods for dynamic, power-efficiency-based cryptographic-protocol negotiation with Internet of Things (IoT) devices. In an embodiment, a computer system (e.g., an identity-management system) receives, from an IoT device, a device-side authentication-initiation message containing a unique device identifier of the IoT device. The computer system uses the unique device identifier of the IoT device to identity, from a stored power-efficiency reference table, a suitable cryptographic security protocol for the IoT device. The computer system transmits, to the IoT device, a server-side authentication-initiation message containing an indication of the identified protocol, and the computer system authenticates the IoT device according to the identified protocol.

### PRIORITY APPLICATION

This application claims priority to Indian Provisional Patent Application Ser. No. 202141030991, filed Jul. 9, 2021, the disclosure of which is incorporated by reference herein in its entirety.

### TECHNICAL FIELD

Among other topics, embodiments of the present disclosure relate to computing and communication systems, identity-management systems, and Internet of Things (IoT) devices, and more particularly to systems and methods for dynamic, power-efficiency-based cryptographic-protocol negotiation with Internet of Things (IoT) devices.

### BACKGROUND

Communication over the Internet by various different systems, computers, devices and the like—and of course by people by way of such systems, computers, devices, etc.—has become nearly ubiquitous in modern life, and its popularity and permeation into many aspects of life is expected to continue to grow. Among the many types of devices that communicate via the Internet are those that are referred to as “Internet of Things” (IoT) devices. Some examples of devices that are often categorized as being IoT devices include temperature sensors, motion sensors, security cameras, home kitchen appliances, and many others. In the context of a given sensor as an example, the sensor may (e.g., periodically) transmit data (e.g., readings, measurements, etc.) to a server, gateway, cloud application, and/or the like: moreover, a network-side entity (e.g., server) may transmit configuration data (e.g., updated thresholds and/or the like) and/or other kinds of data to the sensor from time to time. As a general matter, the information that is transmitted and/or received by IoT devices is often personal or otherwise confidential in nature, and IoT devices (like any networked devices) provide potential points of entry into a given network by hackers and the like. Accordingly, security of IoT-device communication is important.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example communication context in which one or more embodiments of the present disclosure could operate, be performed, and/or the like—the example communication context includes an example identity-management system, an example server system, and a number of example IoT devices.

FIG. 2 illustrates an example message flow between the example identity-management system and an example one of the IoT devices of FIG. 1, in accordance with at least one embodiment.

FIG. 3 depicts an example method that may be performed by the example identity-management system of FIG. 1, in accordance with at least one embodiment.

FIG. 4 depicts an example computer system that could be configured to perform at least one embodiment and/or embody one or more devices, systems, and/or the like in accordance with at least one embodiment.

FIG. 5 depicts an example software architecture that could be implemented on a computer system such as the example computer system of FIG. 4, in accordance with at least one embodiment.

### DETAILED DESCRIPTION

Among other inspirations and motivations, embodiments of the present disclosure arose in part from the realization and recognition that security of communications (for purposes such as authentication, substantive communication, and/or the like) is often an issue for IoT devices for at least the reason that these devices typically do not have heavy-duty processors, significant memory, high-output and high-capacity power sources, etc. That is, IoT devices quite often do not have the sort of processing and power resources that are typically needed for a given device to communicate according to certain complex cryptographic security protocols. A term that is used to describe such devices is “resource-constrained,” and “power-constrained” is another. Indeed, a protocol according to which many IoT devices are configured to communicate is itself named the Constrained Application Protocol (CoAP).

One example of such a protocol is Transport Layer Security (TLS), which uses symmetric-key encryption and is a successor of sorts of Secure Sockets Layer (SSL). Even CoAP, which is known in the art as a relatively “lightweight” protocol that is generally suitable for IoT devices, machine-to-machine (M2M) applications and the like, provides security options for which IoT devices need to support cryptographic security protocols such as the Advanced Encryption Standard (AES) cipher suite, elliptic-curve algorithms, certificate validation, and the like. The implementation of these sorts of complex cryptographic security protocols is typically processor-intensive and power-intensive enough such that, to be realistically used, a certain level of processing hardware and power supply are required. With respect to power supply, it is often the case that IoT devices are battery-powered, sometimes with features such as solar-power-based recharging or the like. As such, avoiding excessive power consumption during operation is often at a premium for IoT devices.

Embodiments of the present disclosure further arose from recognizing and understanding that current implementations of servers, identity-management systems, and the like negotiate which security (e.g., cryptographic) protocol to use for communication with a given IoT device without regard to aspects of the IoT device such as its power efficiency and other capabilities. In typical current implementations, servers handshake and negotiate with IoT devices using. e.g., TLS for authentication without taking the limited (i.e., constrained) nature of the resources of the IoT device into account. Furthermore, embodiments of the present disclosure arose from recognizing and appreciating the importance of the fact that current implementations use handshaking communication with respect to IoT devices that on the whole is too verbose and therefore inefficient.

To address these and other shortcomings of prior implementations, disclosed herein are embodiments of systems and methods for dynamic, power-efficiency-based cryptographic-protocol negotiation with IoT devices. Embodiments of the present disclosure use a socket layer (e.g., the TLS Application-Layer Protocol Negotiation (APLN) extension) to select a cryptographic security protocol for a communication session with a given IoT device. Stated more generally, embodiments of the present disclosure select a strength level of cryptography with which to communicate with a given IoT device based at least in part on capabilities of the given IoT device with respect to aspects such as processing speed, processing power, type of memory, type of power source, and/or the like.

One benefit of embodiments of the present disclosure is a reduction in dialog between server and client with respect to establishing an agreed-upon cryptographic security protocol between the two. One way in which such dialog is reduced, thereby reducing time needed for such handshaking and network traffic involved in such handshaking, is by not sending lists of cryptographic security protocols back and forth between server and client as part of such handshaking, negotiation, and/or the like, as is done in, e.g., a typical TLS negotiation in current implementations.

Furthermore, in at least some embodiments, a given system (e.g., an identity-management system) maintains or at least has access to stored data that contains indications of processing capabilities, power supply, and/or the other capabilities of a number of IoT devices. For simplicity of presentation, characteristics such as these are referred to in the present disclosure as “power-efficiency characteristics” of a given IoT device. Relatedly, data (e.g., a stored profile) that is indicative of such characteristics is referred to herein at times as “power-efficiency data” (e.g., “a power-efficiency profile”) and the like.

In some example implementations, a table (or database, multiple tables, etc.) contains power-efficiency characteristics for a given class of IoT devices. In other cases, the table instead or in addition includes power-efficiency characteristics that are maintained in association with particular IoT-device identifiers such as serial number, model number, tuples of manufacturer and model number, and/or the like. In the present disclosure, such a table (or database or other form of data organization and storage, etc.) is referred to as “a power-efficiency reference table.”

As part of or before engaging in a handshake process with a particular IoT device, a system that is programmed in accordance with one or more embodiments of the present disclosure may obtain (from, e.g., the IoT device) information that the system then uses to index into the power-efficiency reference table to identify a cryptographic security protocol to use for communication (e.g., during a session) with that IoT device. The power-efficiency reference table may include attributes (e.g., columns) such as device and/or device-type identifier, power specifications (“specs”) for the corresponding device or device type, and a list of one or more cryptographic security protocols. The one or more cryptographic security protocols in the list may be protocols according to which the corresponding IoT device or IoT-device type is capable of communicating, protocols according to which the corresponding IoT device or IoT-device type is well-suited to communicating according to, and/or the like. The system may identify a given cryptographic security protocol for a given device and/or device type in this manner, and then utilize the identified cryptographic security protocol for communication with the IoT device.

In any given row of the power-efficiency reference table, the corresponding list of one or more cryptographic security protocols may include one, some, or all of the cryptographic security protocols according to which the corresponding device or device type is capable of communicating. The cryptographic security protocols may be listed in a priority order, and the system may select the highest-priority cryptographic security protocol among the not-yet-tried cryptographic security protocols for communication with the IoT device. In cases where less than all of the cryptographic security protocols according to which the IoT device (or type of IoT device) is capable of communicating, the one or more cryptographic security protocols may have been selected for inclusion in the particular row (and, e.g., placed at a particular priority level) by one or more people of skill in the relevant art that are knowledgeable about which cryptographic security protocol or protocols tend to work best for which IoT devices.

In some embodiments, the list of one or more cryptographic security protocols in the one or more rows of the power-efficiency reference table are selected due to being the strongest cryptographic security protocol that the associated IoT device or type of IoT device can support: in other embodiments, the list of one or more cryptographic security protocols in a given row may or may not prioritize strength of cryptography above all else. In some cases, a recommended cryptographic security protocol may be included in such a list due to it being relatively lightweight—with respect to required processing resources, required power, required communication (e.g., messaging), and/or the like—yet still having a strong enough level of encryption to be an appropriate cryptographic security protocol for the relevant implementation. Such are design choices that can be made by those of skill in the art that have the benefit of the present disclosure.

Furthermore, embodiments of the present disclosure provide a number of benefits, some examples of which are described herein. One example benefit is that, in the growing space that is IoT, embodiments of the present disclosure make the management of IoT-device security, authentication, and the like more reliable, secure, and convenient, among other positive descriptors that could be used here. There are a number of different standard communication protocols and security for authentication. Due at least in part to the maintaining and leveraging of power-efficiency data in accordance with the present disclosure, many IoT devices and types of IoT devices can be easily integrated with a system that dynamically selects cryptographic security protocols for different IoT devices based on their power-efficiency profile. In some instances, a new IoT device can be integrated by, e.g., adding a row particular to that new IoT device into the herein-described power-efficiency reference table, where a corresponding server can then use the information in that new row to select an appropriate cryptographic security protocol for that new device when establishing a communication session between the two.

One embodiment takes the form of a method performed by a computer system executing stored instructions on at least one hardware processor. The method includes receiving, from an IoT device, a device-side authentication-initiation message containing a unique device identifier of the IoT device. The method also includes using the unique device identifier of the IoT device to identify, from a stored power-efficiency reference table, a suitable cryptographic security protocol for the IoT device. The method further includes transmitting, to the IoT device, a server-side authentication-initiation message containing an indication of the identified protocol. The method also includes authenticating the IoT device according to the identified protocol.

As described herein, one or more embodiments of the present disclosure take the form of a method that includes multiple operations. One or more other embodiments take the form of a system that includes at least one hardware processor and that also includes one or more non-transitory computer-readable storage media containing instructions that, when executed by the at least one hardware processor, cause the at least one hardware processor to perform multiple operations (that in some embodiments do and in other embodiments do not correspond to the set of operations performed in a herein-disclosed method embodiment). Still one or more other embodiments take the form of one or more non-transitory computer-readable storage media containing instructions that, when executed by at least one hardware processor, cause the at least one hardware processor to perform multiple operations (that, again, in some embodiments do and in other embodiments do not correspond to the set of operations performed in a herein-disclosed method embodiment and/or the set of operations performed by a herein-disclosed system embodiment).

Furthermore, a number of variations and permutations of the above-listed embodiments are described herein, and it is expressly noted that any variation or permutation that is described in this disclosure can be implemented with respect to any type of embodiment. For example, a variation or permutation that is primarily described in this disclosure in connection with a method embodiment could just as well be implemented in connection with a system embodiment and/or a non-transitory-computer-readable-storage-media embodiment. Furthermore, this flexibility and cross-applicability of embodiments is present in spite of any slightly different language (e.g., processes, process flows, methods, methodologies, steps, operations, functions, and/or the like) that is used to describe and/or characterize such embodiments and/or any element or elements thereof.

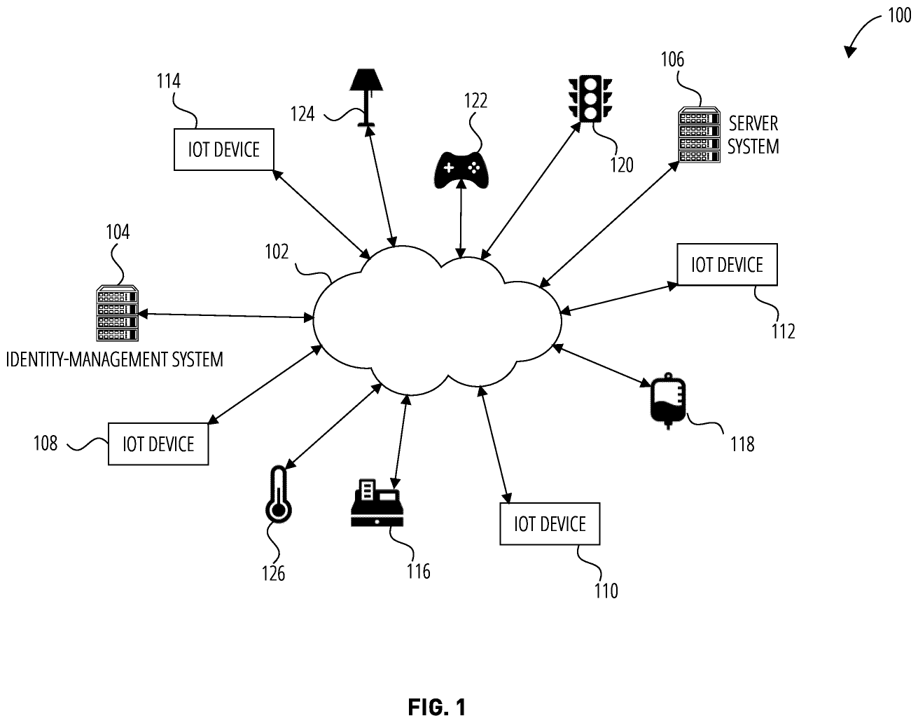

FIG. 1 depicts an example communication context 100 in which one or more embodiments of the present disclosure could operate, be performed, and/or the like. The example communication context 100 includes an example identity-management system 104, an example server system 106, and a number of example IoT devices 108-126, all of which are depicted as being communicatively connected to a network 102. It should be understood that the communication context 100 is provided purely by way of example, and that embodiments of the present disclosure can operate, be performed, and/or the like in numerous different sorts of communication contexts having different numbers, types, and/or arrangements of devices, networks, and/or the like. As examples, there could be different types and/or numbers of IoT devices, different types and/or numbers of server systems, different types and/or numbers of networks, and/or the like.

Moreover, in different embodiments, one or more of the entities that are depicted in FIG. 1 could be distributed across multiple different components. Similarly, two or more of the entities that are depicted in FIG. 1 could be combined into fewer components. One or more functional aspects of any given entity could be realized as a standalone component and/or combined with one or more functional aspects of any one or more other entities. This flexibility with respect to the potential for distribution, centralization, and/or consolidation of functional aspects of the depicted entities also applies to the entities that are depicted in the other figures.

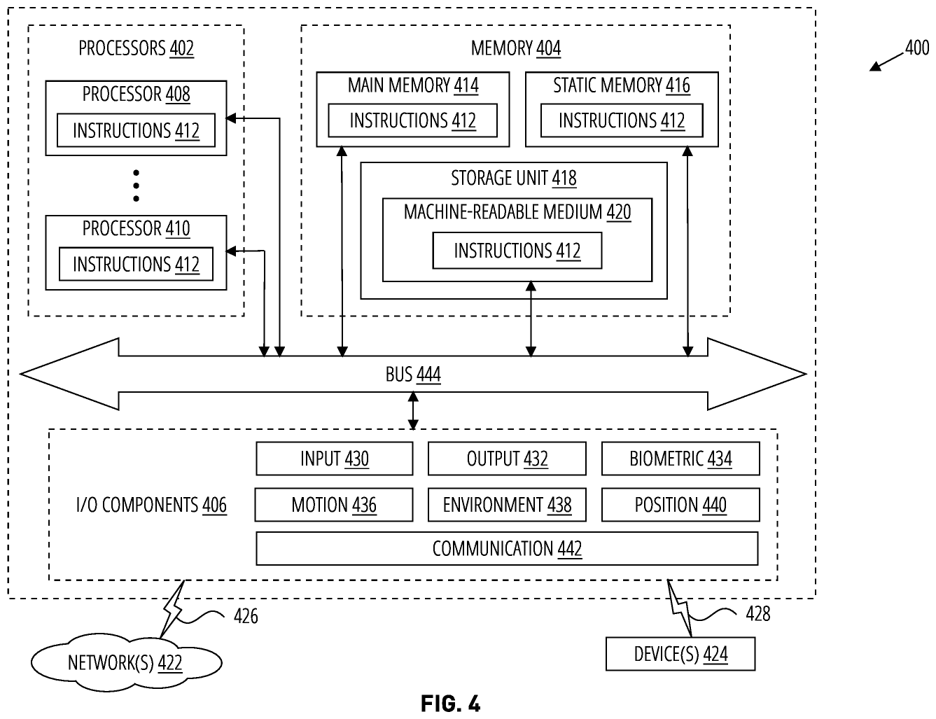

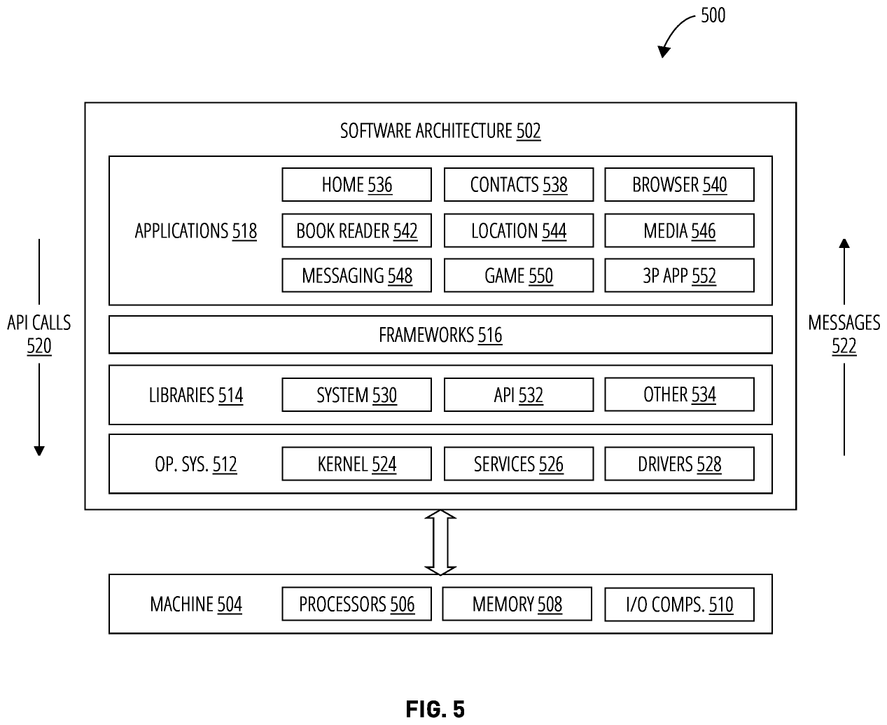

Also with respect to FIG. 1, it is noted that any of the devices, systems, and the like that are depicted in FIG. 1 and/or in any of the other figures could have a hardware architecture that is similar to the hardware architecture that is depicted in and described in connection with the example computer system 400 of FIG. 4, and could contain and execute software having a software architecture that is similar to the example software architecture 502 that is depicted in and described below in connection with FIG. 5. Moreover, any of the communication links (including any one or more that are referred to herein as “secure communication links”) that are depicted in FIG. 1 and/or in any of the other figures could be or include one or more wired-communication links (e.g., Ethernet, fiber optic, Universal Serial Bus (USB), and/or the like) and/or one or more wireless-communication links (e.g., Wi-Fi, 5G, LTE, near-field communication (NFC), Bluetooth, Bluetooth Low Energy, and/or the like). Furthermore, any one or more of the communication links could include one or more intermediate devices such as one or more routers, bridges, servers, access points, base stations, and/or the like. Additionally, any communication link could include one or more virtual private networks (VPNs) and/or other tunneling-type connections.

As depicted, the communication context 100 includes the above-mentioned network 102, identity-management system 104, server system 106, and IoT devices 108-126. The IoT devices 108, 110, 112, and 114 are depicted as generic IoT devices, indicating that embodiments of the present disclosure apply to any kind of IoT devices, and indeed to other devices that are resource-constrained (e.g., processor-constrained, memory-constrained, power-constrained, and/or the like). Some non-generic IoT devices are also presented in FIG. 1, purely by way of example. Those non-generic examples are the IoT device 116 (a point-of-sale device), the IoT device 118 (a medical device—e.g., a portable infuser), the IoT device 120 (a traffic light), the IoT device 122 (a video-game system), the IoT device 124 (a smart lamp, meant to signify any type or types of one or more smart-home IoT devices), and the IoT device 126 (a temperature sensor). The latter IoT device 126 is used by way of example below when discussing various aspects of embodiments of the present disclosure.

In some embodiments, the network 102 is or includes a private data-communication network (e.g., a private Internet Protocol (IP) network). As the term is used herein, a secure communication link could be or include a communication link that is encrypted, that is physically isolated, that is physically protected, and/or the like. In some embodiments, the network 102 could be—or include, or be part of, or be communicatively connected with, etc.—a public data-communication network such as the Internet. The network 102 may operate according to a suite of communication protocols such as the Transmission Control Protocol (TCP) over IP (TCP/IP), the User Datagram Protocol (UDP) over IP (UDP/IP), and/or the like. Two or more of the depicted entities could be communicatively connected via one or more VPNs, which may operate according to a secure tunneling protocol such as IP security (IPSec) or another suitable secure-tunneling protocol. A secure tunnel could traverse a fiber-optic network for some or all of its communication between two endpoints. And numerous other topologies are possible as well.

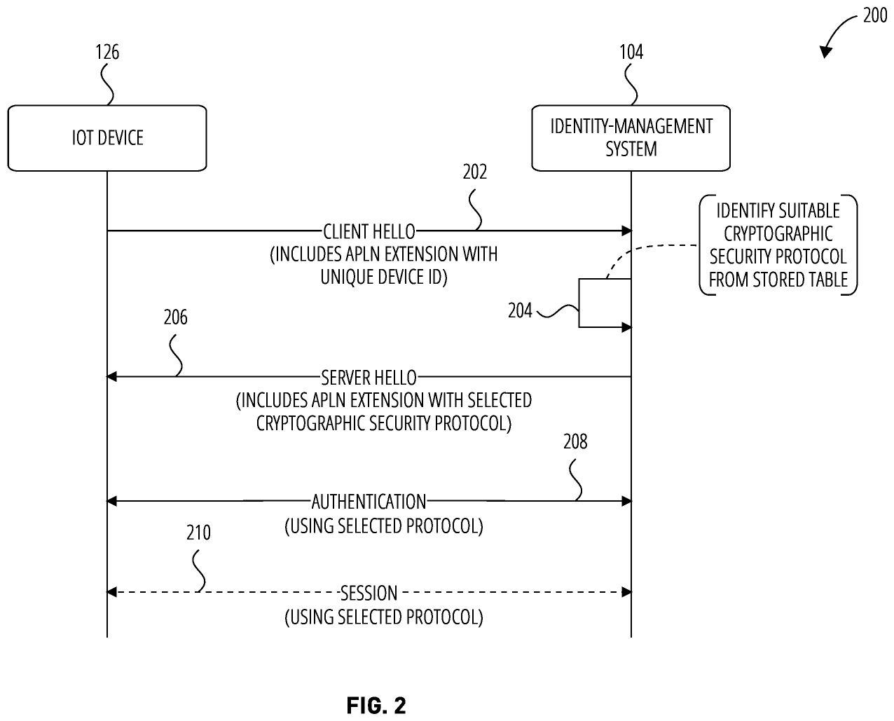

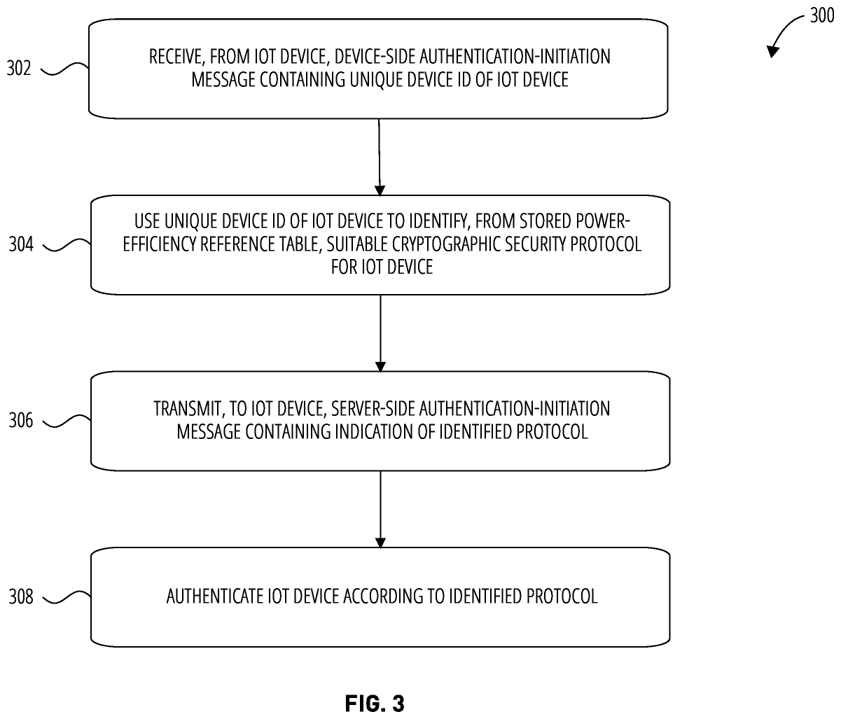

FIG. 2 illustrates an example message flow 200 between the identity-management system 104 and the IoT device 126 of FIG. 1, in accordance with at least one embodiment. The IoT device 126 was arbitrarily selected for inclusion in this example explanation: any other of the IoT devices 108-124 could be similarly used by way of example. It is also noted that the messages and processing that is described here in connection with FIG. 2 is back-referenced below in various parts of the description of the example method 300 of FIG. 3, in respective association with particular operations of that method.

The message flow 200 may represent a situation in which, prior to the messaging and processing that are depicted in FIG. 2, the IoT device 126 made a determination to authenticate to the identity-management system 104. In some cases, the IoT device 126 may initially contact another entity such as the server system 106, which may redirect the IoT device 126 to the identity-management system 104. If and when successful authentication of the IoT device 126 is achieved by the identity-management system 104, the identity-management system 104 may redirect the IoT device 126 back to the server system 106, or the IoT device 126 may be programmed to automatically direct itself back to the server system 106, among numerous other configurations that could be implemented.

The message flow 200 begins with the IoT device 126 transmitting a client-hello message 202 to the identity-management system 104. In some embodiments, including in the embodiment that is depicted by way of example and not limitation in FIG. 2, the IoT device 126 and the identity-management system 104 communicate according to an extension of TLS that is known in the art as the TLS Application-Layer Protocol Negotiation (APLN) extension, and which is referred to in the present disclosure at various different times using names such as “the TLS APLN extension,” just “the APLN extension.” and/or the like.

The TLS APLN extension was designed at least in part to reduce the extent of authentication dialog that is conducted between devices such as the identity-management system 104 and the IoT device 126. Among the features of the TLS APLN extension that are related to that goal is the implementation of a parameter called “ProtocolNameList” in client-hello messages: using that parameter, the TLS APLN directs a client device such as the IoT device 126 to include in the ProtocolNameList parameter a list of cryptographic security protocols of which the IoT device 126 is capable of communicating, prefers to communicate, and/or the like. In accordance with the present disclosure, some embodiments involve IoT devices such as the IoT device 126 including an identifier of itself in the ProtocolNameList field.

That identifier is further described below and is referred to herein as the “UniqueDeviceID.” In at least some embodiments, the UniqueDeviceID of a given IoT (or other type of) device is or includes a unique hardware identifier of the given device, assigned to the given device by, e.g., its manufacture at or soon after the time of manufacture of the given IoT device. It should be appreciated that use of this particular field (parameter) of the TLS APLN, and indeed the use of the TLS APLN extension at all, are provided by way of example and not limitation. In some such embodiments, the relevant IoT device further includes one or more power specifications that are descriptive of the power-efficiency characteristics of the given IoT device.

Upon receiving the client-hello message 202, the identity-management system 104 conducts an operation 204 at which the identity-management system 104 identifies a suitable cryptographic security protocol for the IoT device 126. Some example ways in which the identity-management system 104 may identify such as cryptographic security protocol at operation 204 are discussed both above and below in the present disclosure. As described by way of example herein, the operation 204 may include the identity-management system 104 referencing a stored table (e.g., a power-efficiency reference table), database, and/or the like: in some embodiments, the identity-management system 104 uses the received UniqueDeviceID of the associated IoT device as an index into such a table.

Once having identified the aforementioned suitable cryptographic security protocol, the identity-management system 104 transmits a server-hello message 206 to the IoT device 126. In at least one embodiment, the identity-management system 104 includes the identified (e.g., selected) cryptographic security protocol in the server-hello message 206. The IoT device 126 and the identity-management system 104 may then engage in an authentication process 208 according to the selected cryptographic security protocol. The authentication process 208 may involve calculation of shared secrets, use of one or more symmetric keys, use of one or more asymmetric keys, various different strengths of encryption, and/or the like. Those of skill in the art are familiar with authentication processes according to various different cryptographic security protocols.

In some embodiments, following the authentication process 208, the identity-management system 104 engages in a communication session 210 with the IoT device 126. The communication session 210 is shown using a dotted line to indicate its optional nature: as discussed above, the identity-management system 104 or perhaps the IoT device 126 itself may, post authentication, redirect the IoT device 126 to another device, system of one or more servers (e.g., the server system 106), and/or the like. In some embodiments, the identity-management system 104 and the IoT device 126 engage in the communication session 210 according to a protocol other than the cryptographic security protocol that was selected by the identity-management system 104 and used for the authentication process 208.

FIG. 3 depicts a method 300 that is described here by way of example as being performed by the identity-management system 104. In general, however, the method 300 can be performed by any suitable computing and communication device that is programmed to perform the recited functions. Moreover, it should be understood that every permutation and combination of every embodiment that is disclosed herein can be applied as a permutation, embodiment, or the like of the method 300. As a general matter, unless dictated by logical dependency, the order in which the operations of the method 300 are listed is not meant as a limitation, and certainly the operations can be performed in various different orders.

At operation 302, the identity-management system 104 receives, from an IoT device, a device-side authentication-initiation message containing a unique device identifier of the IoT device. In an embodiment, that message could be the client-hello message 202 of FIG. 2. Thus, at least some embodiments of the present disclosure leverage the TLS ALPN extension to select a power-efficiency-appropriate cryptographic protocol with which to communicate with a given IoT device for a given session, time period, until a certain event, and/or the like.

As mentioned above, in at least one embodiment, the UniqueDeviceID of a given IoT device is or at least includes a hardware identifier of that IoT device. That hardware identifier may have been assigned to that IoT device at the time of manufacture. In various different embodiments, a UniqueDeviceID could take the form of a numeric or alphanumeric identifier, as examples. In some embodiments, the power-efficiency reference table is organized such that the identity-management system 104 uses the received UniqueDeviceID as an index into the power-efficiency reference table. Some example identifiers that could be used in various different embodiments as the UniqueDeviceID include serial number, electronic serial number (ESN), international mobile equipment identity (IMEI), media access control (MAC) address, wireless MAC address, integrated circuit card ID (ICCID), and the like.

At operation 304, the identity-management system 104 uses the unique device identifier (received at operation 302) of the IoT device 126 that is received at operation 302 to identify, from a stored power-efficiency reference table, a suitable cryptographic security protocol for the IoT device 126. Table 1 below shows an example power-efficiency reference table.

TABLE 1
Example Power-Efficiency Reference Table

| | | Cryptographic Security |
|---|---|---|
| UniqueDeviceID | Power Specs | Protocol(s) |
| device92678 | PowerSpecSet_32 | {CSP03} |
| device126 | PowerSpecSet_4A | {CSP05} |
| device50116 | PowerSpecSet_32 | {CSP03, CSP05} |
| device42111 | PowerSpecSet_7F | {CSP11} |
| device83007 | PowerSpecSet_55 | {CSP14} |

There could be any number of IoT devices in a given power-efficiency reference table, and five are shown by way of example in Table 1. The device identifiers shown in Table 1 are arbitrary, though the one in the second row is meant to correspond to the IoT device 126 in accordance with the above example. As can be seen in the example table, each row includes a UniqueDeviceID of a given IoT device, a set of what are referred to herein as “power specs” (i.e., power specifications) of the corresponding IoT device in that row, and a set of one or more cryptographic security protocols deemed suitable for the respective devices. These cryptographic security protocols could be set by manufacturers, experts in other organizations, and/or the like, among many other possible approaches. As stated above, in some embodiments, the power-efficiency reference table is indexed at least by unique device identifiers of IoT devices listed in the table.

The identifiers of cryptographic security protocols in the table (e.g., “CSP03”) are not meant to correspond to particular specific cryptographic security protocols in use in the industry, but rather are simply arbitrarily chosen identifiers for the present disclosure. As a slight aside, it is noted that what are largely referred to in the present disclosure as “cryptographic security protocols” are referred to at times by those of skill in the art as being “security algorithms,” “cryptographic algorithms,” and/or the like. The use of “cryptographic security protocols” in the present disclosure is intended to cover terms such as those and others that those of skill in the art use from time to time.

As shown in the example Table 1, some IoT devices are associated with a single cryptographic security protocol. Indeed, in at least one embodiment, every IoT device in a power-efficiency reference table such as Table 1 are each associated with exactly one cryptographic security protocol. In other embodiments, the power-efficiency reference table includes multiple suitable cryptographic security protocols for at least one IoT device. In some such embodiments, those multiple suitable cryptographic security protocols in the power-efficiency reference table for a given IoT device are arranged (e.g., designated) in a priority order for the identity-management system 104 to use in attempting to authenticate of the corresponding IoT device. To be associated with a given priority, it is not necessary that a set of cryptographic security protocols be listed in a particular priority order, although that is certainly an option. In some implementations, each of multiple cryptographic security protocols that are associated with a given IoT device have stored therewith a priority value.

With respect to the example power specs that are shown in Table 1, those identifiers (e.g., “PowerSpecSet_4A” for the IoT device 126) were also arbitrarily selected for the present disclosure. In various different embodiments, the set of one or more power specifications of the corresponding IoT device that is stored in the power-efficiency reference table could include parameters such as operating voltage (e.g., Vₜₜ) (e.g., 5 volts (V). 10 V, etc.), operating current (e.g., 30 milliamperes (a.k.a. milliamps) (mA), 1 amp, and/or the like), power source (e.g., battery, battery pack, etc.), battery details such as battery type, battery size, and/or the like. Certainly other power-related specifications of a given IoT device could be used as well or instead of those examples. In at least one embodiment, the power-efficiency reference table is queryable by sets of one or more power specs, such that, e.g., an IoT device that does not yet have an entry in the table could have selected for it a cryptographic security protocol that is suitable for at least one device having a similar power-spec profile. In some embodiments, however, the power specs column is not in the power-efficiency reference table at all: indeed, in some such embodiments, the only two columns in the power-efficiency reference table are the “UniqueDeviceID” and the “Cryptographic Security Protocols” (or similarly named and constituted) columns.

At operation 306, the identity-management system 104 transmits, to the IoT device 126, a server-side authentication-initiation message that contains an indication of the identified (e.g., selected) cryptographic security protocol for the IoT device 126. As shown in the example message flow 200 of FIG. 2, the server-side authentication-initiation message of operation 306 could be an APLN-extension server-hello message such as the server-hello message 206 of FIG. 2.

At operation 308, the identity-management system 104 authenticates the IoT device according to the identified protocol. In an embodiment, the identity-management system 104 performing the operation 308 takes the form of or at least includes the identity-management system 104 conducting the authentication process 208 with, e.g., the IoT device 126. In some implementations, including those that utilize the TLS APLN extension, the identity-management system 104 can use different protocols on the same port in communication with different IoT devices. Thus, the socket layer referred to as the TLS APLN extension, once implemented with intelligence to select a cryptographic security protocol for a given IoT device based on that device's power efficiency in accordance with embodiments of the present disclosure, will facilitate IoT devices negotiating for strong cryptographic security protocols that the respective devices can handle.

From time to time, the identity-management system 104 may receive an update message that pertains to a given IoT device (e.g., the IoT device 126). In at least some instances, that update message includes an indication (identification and/or the like) of a cryptographic security protocol other than the cryptographic security protocol that is indicated in the power-efficiency reference table. The identity-management system 104 may responsively replace, in the corresponding row of the power-efficiency reference table, the indication of the current cryptographic security protocol with an indication of the replacement cryptographic security protocol. In future interactions with the corresponding IoT device, then, the identity-management system 104 may identify the replacement cryptographic security protocol as a cryptographic security protocol that is suitable, recommended, and/or the like for that particular IoT device.

FIG. 4 depicts an example computer system 400 that could be utilized to embody and/or perform at least one embodiment, and within which instructions 412 (e.g., software, a program, an application, an applet, an app, and/or other executable code) may be executed to cause the computer system 400 to perform any one or more of the methodologies discussed herein. For example, execution of the instructions 412 may cause the computer system 400 to perform any one or more of the methods described herein. The instructions 412 transform the general, non-programmed computer system 400 into a particular computer system 400 programmed to carry out the described and illustrated functions in the manner described. The computer system 400 may operate as a standalone device or may be coupled (e.g., networked) to other machines. In a networked deployment, the computer system 400 may operate in the capacity of a server machine or a client machine in a server-client network environment, or as a peer machine in a peer-to-peer (or distributed) network environment.

The computer system 400 may be or include, but is limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, and/or any other machine capable of executing the instructions 412, sequentially or otherwise, that specify actions to be taken by the computer system 400. Further, while only a single computer system 400 is illustrated, the term “machine” shall also be taken to include a collection of machines that individually or jointly execute the instructions 412 to perform any one or more of the methodologies discussed herein.

The computer system 400 may include processors 402, memory 404, and I/O components 406, which may be configured to communicate with each other via a bus 444. In an example embodiment, the processors 402 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, for example, a processor 408 and a processor 410 that execute the instructions 412. The term “processor” is intended to include multi-core processors that may include two or more independent processors (sometimes referred to as “cores”) that may execute instructions contemporaneously. Although FIG. 4 shows multiple processors 402, the computer system 400 may include a single processor with a single core, a single processor with multiple cores (e.g., a multi-core processor), multiple processors with a single core, multiple processors with multiples cores, or any combination thereof.

The memory 404 includes a main memory 414, a static memory 416, and a storage unit 418, each of which is accessible to the processors 402 via the bus 444. The memory 404, the static memory 416, and/or the storage unit 418 may store the instructions 412 executable for performing any one or more of the methodologies or functions described herein. The instructions 412 may also or instead reside completely or partially within the main memory 414, within the static memory 416, within machine-readable medium 420 within the storage unit 418, within at least one of the processors 402 (e.g., within a cache memory of a given one of the processors 402), and/or any suitable combination thereof, during execution thereof by the computer system 400. The machine-readable medium 420 is one or more non-transitory computer-readable storage media.

The I/O components 406 may include a wide variety of components to receive input, produce and/or provide output, transmit information, exchange information, capture measurements, and/or the like. The specific I/O components 406 that are included in a particular instance of the computer system 400 will depend on the type of machine. For example, portable machines such as mobile phones may include a touch input device or other such input mechanisms, while a headless server machine may not include such a touch input device. It will be appreciated that the I/O components 406 may include many other components that are not shown in FIG. 4.

In various example embodiments, the I/O components 406 may include output components 432 and input components 430. The output components 432 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth. The input components 430 may include alphanumeric input components (e.g., a keyboard, a touchscreen configured to receive alphanumeric input, a photo-optical keyboard, and/or other alphanumeric input components), point-based input components (e.g., a mouse, a touchpad, a trackball, a joystick, a motion sensor, and/or one or more other pointing instruments), tactile input components (e.g., a physical button, a touchscreen that is responsive to location and/or force of touches or touch gestures, and/or one or more other tactile input components), audio input components (e.g., a microphone), and/or the like.

In further example embodiments, the I/O components 406 may include biometric components 434, motion components 436, environmental components 438, and/or position components 440, among a wide array of other components. The biometric components 434 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, and/or electroencephalogram-based identification), and/or the like. The motion components 436 may include acceleration-sensing components (e.g., an accelerometer), gravitation-sensing components, rotation-sensing components (e.g., a gyroscope), etc.

The environmental components 438 may include, for example, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors that detect nearby objects), gas-sensing components (e.g., gas-detection sensors to detection concentrations of hazardous gases for safety and/or to measure pollutants in the atmosphere), and/or other components that may provide indications, measurements, signals, and/or the like that correspond to a surrounding physical environment. The position components 440 may include location-sensing components (e.g., a global positioning system (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 406 may further include communication components 442 operable to communicatively couple the computer system 400 to a network 422 and/or devices 424 via a coupling 426 and/or a coupling 428, respectively. For example, the communication components 442 may include a network-interface component or another suitable device to interface with the network 422. In further examples, the communication components 442 may include wired-communication components, wireless-communication components, cellular-communication components, Near Field Communication (NFC) components, Bluetooth (e.g., Bluetooth Low Energy) components. Wi-Fi components, and/or other communication components to provide communication via one or more other modalities. The devices 424 may include one or more other machines and/or any of a wide variety of peripheral devices (e.g., a peripheral device coupled via a universal serial bus (USB) connection).

Moreover, the communication components 442 may detect identifiers or include components operable to detect identifiers. For example, the communication components 442 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 442, such as location via Internet Protocol (IP) geolocation, location via Wi-Fi signal triangulation, location via detecting an NFC beacon signal that may indicate a particular location, and/or the like.

One or more of the various memories (e.g., the memory 404, the main memory 414, the static memory 416, and/or the (e.g., cache) memory of one or more of the processors 402) and/or the storage unit 418 may store one or more sets of instructions (e.g., software) and/or data structures embodying or used by any one or more of the methodologies or functions described herein. These instructions (e.g., the instructions 412), when executed by one or more of the processors 402, cause various operations to implement various embodiments of the present disclosure.

The instructions 412 may be transmitted or received over the network 422, using a transmission medium, via a network-interface device (e.g., a network-interface component included in the communication components 442) and using any one of a number of well-known transfer protocols (e.g., the Session Initiation Protocol (SIP), the hypertext transfer protocol (HTTP), and/or the like). Similarly, the instructions 412 may be transmitted or received using a transmission medium via the coupling 428 (e.g., a peer-to-peer coupling) to the devices 424.

FIG. 5 depicts an example software architecture 502 that could be executed on the example computer system 400 of FIG. 4, in accordance with at least one embodiment. The illustrated example software architecture 502 can be installed on any one or more of the devices described herein. For example, the software architecture 502 could be installed on any device or system that is arranged similar to the computer system 400 of FIG. 4. The software architecture 502 is supported by hardware such as a machine 504 that includes processors 506, memory 508, and I/O components 510. In this example, the software architecture 502 can be conceptualized as a stack of layers, where each layer provides a particular functionality. The software architecture 502 includes layers such an operating system 512, libraries 514, frameworks 516, and applications 518. Operationally, using one or more application programming interfaces (APIs), the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 may provide memory management, processor management (e.g., scheduling), component management, networking, and/or security settings, in some cases among other functionality. The services 526 can provide other common services for the other software layers. The drivers 528 are responsible for controlling or interfacing with the underlying hardware. For instance, the drivers 528 can include display drivers, camera drivers, Bluetooth or Bluetooth Low Energy drivers, flash memory drivers, serial communication drivers (e.g., USB drivers), Wi-Fi drivers, audio drivers, power management drivers, and/or the like.

The libraries 514 provide a low-level common infrastructure used by the applications 518. The libraries 514 can include system libraries 530 (e.g., a C standard library) that provide functions such as memory-allocation functions, string-manipulation functions, mathematic functions, and/or the like. In addition, the libraries 514 can include API libraries 532 such as media libraries (e.g., libraries to support presentation and/or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), and/or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), and/or the like. The libraries 514 can also include a wide variety of other libraries 534 to provide many other APIs to the applications 518.

The frameworks 516 may provide a high-level common infrastructure that is used by the applications 518. For example, the frameworks 516 may provide various graphical user interface (GUI) functions, high-level resource management, high-level location services, and/or the like. The frameworks 516 can provide a broad spectrum of other APIs that can be used by the applications 518, some of which may be specific to a particular operating system or platform.

Purely as representative examples, the applications 518 may include a home application 536, a contacts application 538, a browser application 540, a book-reader application 542, a location application 544, a media application 546, a messaging application 548, a game application 550, and/or a broad assortment of other applications generically represented in FIG. 5 as a third-party application 552. The applications 518 are programs that execute functions defined in the programs. Various programming languages can be employed to create one or more of the applications 518, structured in a variety of manners, such as object-oriented programming languages (e.g., Objective-C, Java, C++, etc.), procedural programming languages (e.g., C, assembly language, etc.), and/or the like. In a specific example, the third-party application 552 (e.g., an application developed using the ANDROID™ or IOS™ software development kit (SDK) by an entity other than the vendor of the particular platform) could be mobile software running on a mobile operating system such as IOS™, ANDROID™, WINDOWS® Phone, and/or the like. In this example, the third-party application 552 can invoke the API calls 520 provided by the operating system 512 to facilitate functionality described herein.

In view of the disclosure above, a listing of various examples of embodiments is set forth below. It should be noted that one or more features of an example, taken in isolation or combination, should be considered within the disclosure of this application.

Example 1 is a method performed by a computer system executing stored instructions on at least one hardware processor, the method including: receiving, from an IoT device, a device-side authentication-initiation message containing a unique device identifier of the IoT device; using the unique device identifier of the IoT device to identify, from a stored power-efficiency reference table, a suitable cryptographic security protocol for the IoT device; transmitting, to the IoT device, a server-side authentication-initiation message containing an indication of the identified protocol; and authenticating the IoT device according to the identified protocol.

Example 2 is the method of Example 1, where the device-side authentication-initiation message includes a client-hello message according to a TLS APLN extension; and the server-side authentication-initiation message includes a server-hello message according to the TLS APLN extension.

Example 3 is the method of either Example 1 or Example 2, where, for each IoT device in a plurality of IoT devices, the power-efficiency reference table includes a unique device identifier of the corresponding IoT device and at least one suitable cryptographic security protocol for the corresponding IoT device.

Example 4 is the method of Example 3, where, for each IoT device in the plurality of IoT devices, the power-efficiency reference table includes exactly one suitable cryptographic security protocol for the corresponding IoT device.

Example 5 is the method of Example 3, where, for at least one IoT device in the plurality of IoT devices, the power-efficiency reference table includes multiple suitable cryptographic security protocols for the corresponding IoT device.

Example 6 is the method of Example 5, where the multiple suitable cryptographic security protocols in the power-efficiency reference table for at least one IoT device in the plurality of IoT devices are arranged in a priority order for the computer system to use in attempting to authenticate of the corresponding IoT device.

Example 7 is the method of any of the Examples 1-6, where the power-efficiency reference table is indexed at least by unique device identifiers of IoT devices listed in the power-efficiency reference table.

Example 8 is the method of any of the Examples 1-7, where, for each IoT device of the plurality of IoT devices, the power-efficiency reference table further includes a set of one or more power specifications of the corresponding IoT device.

Example 9 is the method of any of the Examples 1-8, further including engaging in a communication session with the IoT device according to the identified protocol.

Example 10 is the method of any of the Examples 1-9, further including: receiving an update message pertaining to a given IoT device in the plurality of IoT devices, the update message including a second indication of a second cryptographic security protocol, the second cryptographic security protocol being different than a first cryptographic security protocol of which a first indication is currently listed in the power-efficiency reference table in connection with the given IoT device; and responsively replacing the first indication of the first cryptographic security protocol with the second indication of the second cryptographic security protocol in connection with the given IoT device.

Example 11 is a computer system that includes at least one hardware processor and that also includes one or more non-transitory computer-readable storage media containing instructions that, when executed by the at least one hardware processor, cause the computer system to perform operations including: receiving, from an IoT device, a device-side authentication-initiation message containing a unique device identifier of the IoT device; using the unique device identifier of IoT device to identify, from a stored power-efficiency reference table, a suitable cryptographic security protocol for the IoT device; transmitting, to the IoT device, a server-side authentication-initiation message containing an indication of the identified protocol; and authenticating the IoT device according to the identified protocol.

Example 12 is the computer system of Example 11, where the device-side authentication-initiation message includes a client-hello message according to a TLS APLN extension; and the server-side authentication-initiation message includes a server-hello message according to the TLS APLN extension.

Example 13 is the computer system of either Example 11 or Example 12, where, for each IoT device in a plurality of IoT devices, the power-efficiency reference table includes a unique device identifier of the corresponding IoT device and at least one suitable cryptographic security protocol for the corresponding IoT device.

Example 14 is the computer system of Example 13, where, for each IoT device in the plurality of IoT devices, the power-efficiency reference table includes exactly one suitable cryptographic security protocol for the corresponding IoT device.

Example 15 is the computer system of Example 13, where, for at least one IoT device in the plurality of IoT devices, the power-efficiency reference table includes multiple suitable cryptographic security protocols for the corresponding IoT device.

Example 16 is the computer system of Example 15, where the multiple suitable cryptographic security protocols in the power-efficiency reference table for at least one IoT device in the plurality of IoT devices are arranged in a priority order for the computer system to use in attempting to authenticate of the corresponding IoT device.

Example 17 is the computer system of any of the Examples 11-16, where the power-efficiency reference table is indexed at least by unique device identifiers of IoT devices listed in the power-efficiency reference table.

Example 18 is the computer system of any of the Examples 11-17, where, for each IoT device of the plurality of IoT devices, the power-efficiency reference table further includes a set of one or more power specifications of the corresponding IoT device.

Example 19 is the computer system of any of the Examples 11-18, the operations further including engaging in a communication session with the IoT device according to the identified protocol.

Example 20 is the computer system of any of the Examples 11-19, the operations further including: receiving an update message pertaining to a given IoT device in the plurality of IoT devices, the update message including a second indication of a second cryptographic security protocol, the second cryptographic security protocol being different than a first cryptographic security protocol of which a first indication is currently listed in the power-efficiency reference table in connection with the given IoT device; and responsively replacing the first indication of the first cryptographic security protocol with the second indication of the second cryptographic security protocol in connection with the given IoT device.

Example 21 is one or more non-transitory computer-readable storage media containing instructions that, when executed by at least one hardware processor of a computer system, cause the computer system to perform operations including: receiving, from an IoT device, a device-side authentication-initiation message containing a unique device identifier of the IoT device; using the unique device identifier of IoT device to identify, from a stored power-efficiency reference table, a suitable cryptographic security protocol for the IoT device; transmitting, to the IoT device, a server-side authentication-initiation message containing an indication of the identified protocol; and authenticating the IoT device according to the identified protocol.

Example 22 is the one or more non-transitory computer-readable storage media of Example 21, where the device-side authentication-initiation message includes a client-hello message according to a TLS APLN extension; and the server-side authentication-initiation message includes a server-hello message according to the TLS APLN extension.

Example 23 is the one or more non-transitory computer-readable storage media of either Example 21 or Example 22, where, for each IoT device in a plurality of IoT devices, the power-efficiency reference table includes a unique device identifier of the corresponding IoT device and at least one suitable cryptographic security protocol for the corresponding IoT device.

Example 24 is the one or more non-transitory computer-readable storage media of Example 23, where, for each IoT device in the plurality of IoT devices, the power-efficiency reference table includes exactly one suitable cryptographic security protocol for the corresponding IoT device.

Example 25 is the one or more non-transitory computer-readable storage media of Example 23, where, for at least one IoT device in the plurality of IoT devices, the power-efficiency reference table includes multiple suitable cryptographic security protocols for the corresponding IoT device.

Example 26 is the one or more non-transitory computer-readable storage media of Example 25, where the multiple suitable cryptographic security protocols in the power-efficiency reference table for at least one IoT device in the plurality of IoT devices are arranged in a priority order for the computer system to use in attempting to authenticate of the corresponding IoT device.

Example 27 is the one or more non-transitory computer-readable storage media of any of the Examples 21-26, where the power-efficiency reference table is indexed at least by unique device identifiers of IoT devices listed in the power-efficiency reference table.

Example 28 is the one or more non-transitory computer-readable storage media of any of the Examples 21-27, where, for each IoT device of the plurality of IoT devices, the power-efficiency reference table further includes a set of one or more power specifications of the corresponding IoT device.

Example 29 is the one or more non-transitory computer-readable storage media of any of the Examples 21-28, the operations further including engaging in a communication session with the IoT device according to the identified protocol.

Example 30 is the one or more non-transitory computer-readable storage media of any of the Examples 21-29, the operations further including: receiving an update message pertaining to a given IoT device in the plurality of IoT devices, the update message including a second indication of a second cryptographic security protocol, the second cryptographic security protocol being different than a first cryptographic security protocol of which a first indication is currently listed in the power-efficiency reference table in connection with the given IoT device; and responsively replacing the first indication of the first cryptographic security protocol with the second indication of the second cryptographic security protocol in connection with the given IoT device.

To promote an understanding of the principles of the present disclosure, various embodiments are illustrated in the drawings. The embodiments disclosed herein are not intended to be exhaustive or to limit the present disclosure to the precise forms that are disclosed in the above detailed description. Rather, the described embodiments have been selected so that others skilled in the art may utilize their teachings. Accordingly, no limitation of the scope of the present disclosure is thereby intended.

Any component of a device, system, and/or the like that is referred to in the present disclosure as a module includes both hardware and executable instructions, and could be realized in or as a single component or could be distributed across multiple components. When executed by the hardware, the instructions cause the hardware to perform (e.g., execute, carry out, and the like) the one or more operations (e.g., functions) that are described herein as being performed by the module. The hardware could include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more hardware devices and/or hardware components of any other type deemed suitable by those of skill in the art for a given implementation. The instructions could include hardware (e.g., hardwired) instructions, firmware instructions, software instructions, and/or the like, stored in any one or more non-transitory computer-readable storage media deemed suitable by those of skill in the art for a given implementation. Each such non-transitory computer-readable storage medium could be or include memory (e.g., random access memory (RAM), read-only memory (ROM), erasable programmable read-only memory (EPROM), electrically erasable programmable read-only memory (EEPROM a.k.a. E2PROM), flash memory, and/or one or more other types of memory) and/or one or more other types of non-transitory computer-readable storage medium.

In any instances in this disclosure, including in the claims, in which numeric modifiers such as first, second, and third are used in reference to components, data (e.g., values, identifiers, parameters, and/or the like), and/or any other elements, such use of such modifiers is not intended to denote or dictate any specific or required order of the elements that are referenced in this manner. Rather, any such use of such modifiers is intended to assist the reader in distinguishing elements from one another, and should not be interpreted as insisting upon any particular order or carrying any other significance, unless such an order or other significance is clearly and affirmatively explained herein.

Additionally, as used in this disclosure, phrases of the form “at least one of A and B,” “at least one of A, B, and C,” and the like should be interpreted as if the language “A and/or B,” “A, B, and/or C,” and the like had been used in place of the entire phrase. Unless explicitly stated otherwise in connection with a particular instance, in this disclosure, this manner of phrasing does not mean “at least one of A and at least one of B,” “at least one of A, at least one of B, and at least one of C,” and so on. As used in this disclosure, the two-element version covers each of the following: one or more of A and no B, one or more of B and no A. and one or more of A and one or more of B. And similarly for the three-element version and beyond. Similar construction should be given to such phrases in which “one or more” is used in place of “at least one,” again unless explicitly stated otherwise in connection with a particular instance.

Moreover, consistent with the fact that the entities and arrangements that are described herein, including the entities and arrangements that are depicted in and described in connection with the drawings, are presented as examples and not by way of limitation, any and all statements or other indications as to what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively self-qualified by such a clause. It is for reasons akin to brevity and clarity of presentation that this implied self-qualifying clause is not repeated ad nauseum in this disclosure.

1. A method performed by a computer system executing stored instructions on at least one hardware processor, the method comprising:
receiving, from an Internet of Things (IoT) device, a device-side authentication-initiation message containing a unique device identifier of the IoT device;
using the unique device identifier of the IoT device to identify, from a stored power-efficiency reference table, a suitable cryptographic security protocol for the IoT device;
transmitting, to the IoT device, a server-side authentication-initiation message containing an indication of the identified protocol; and
authenticating the IoT device according to the identified protocol.

2. The method of claim 1, wherein:
the device-side authentication-initiation message comprises a client-hello message according to a Transport Layer Security (TLS) Application-Layer Protocol Negotiation (APLN) extension; and
the server-side authentication-initiation message comprises a server-hello message according to the TLS APLN extension.

3. The method of claim 1, wherein, for each IoT device in a plurality of IoT devices, the power-efficiency reference table comprises a unique device identifier of the corresponding IoT device and at least one suitable cryptographic security protocol for the corresponding IoT device.

4. The method of claim 3, wherein, for each IoT device in the plurality of IoT devices, the power-efficiency reference table comprises exactly one suitable cryptographic security protocol for the corresponding IoT device.

5. The method of claim 3, wherein, for at least one IoT device in the plurality of IoT devices, the power-efficiency reference table comprises multiple suitable cryptographic security protocols for the corresponding IoT device.

6. The method of claim 5, wherein the multiple suitable cryptographic security protocols in the power-efficiency reference table for at least one IoT device in the plurality of IoT devices are arranged in a priority order for the computer system to use in attempting to authenticate of the corresponding IoT device.

7. The method of claim 1, wherein the power-efficiency reference table is indexed at least by unique device identifiers of IoT devices listed in the power-efficiency reference table.

8. The method of claim 3, wherein, for each IoT device of the plurality of IoT devices, the power-efficiency reference table further comprises a set of one or more power specifications of the corresponding IoT device.

9. The method of claim 1, further comprising engaging in a communication session with the IoT device according to the identified protocol.

10. The method of claim 3, further comprising:
receiving an update message pertaining to a given IoT device in the plurality of IoT devices, the update message comprising a second indication of a second cryptographic security protocol, the second cryptographic security protocol being different than a first cryptographic security protocol of which a first indication is currently listed in the power-efficiency reference table in connection with the given IoT device; and
responsively replacing the first indication of the first cryptographic security protocol with the second indication of the second cryptographic security protocol in connection with the given IoT device.

11. A computer system comprising:
at least one hardware processor; and
one or more non-transitory computer-readable storage media containing instructions that, when executed by the at least one hardware processor, cause the computer system to perform operations comprising:
receiving, from an Internet of Things (IoT) device, a device-side authentication-initiation message containing a unique device identifier of the IoT device;
using the unique device identifier of IoT device to identify, from a stored power-efficiency reference table, a suitable cryptographic security protocol for the IoT device;
transmitting, to the IoT device, a server-side authentication-initiation message containing an indication of the identified protocol; and
authenticating the IoT device according to the identified protocol.

12. The computer system of claim 11, wherein:
the device-side authentication-initiation message comprises a client-hello message according to a Transport Layer Security (TLS) Application-Layer Protocol Negotiation (APLN) extension; and
the server-side authentication-initiation message comprises a server-hello message according to the TLS APLN extension.

13. The computer system of claim 11, wherein, for each IoT device of a plurality of IoT devices, the power-efficiency reference table comprises a unique device identifier of the corresponding IoT device and at least one suitable cryptographic security protocol for the corresponding IoT device.

14. The computer system of claim 13, wherein, for each IoT device in the plurality of IoT devices, the power-efficiency reference table comprises exactly one suitable cryptographic security protocol for the corresponding IoT device.

15. The computer system of claim 13, wherein:
for at least one IoT device in the plurality of IoT devices, the power-efficiency reference table comprises multiple suitable cryptographic security protocols for the corresponding IoT device; and
wherein the multiple suitable cryptographic security protocols in the power-efficiency reference table for at least one IoT device in the plurality of IoT devices are arranged in a priority order for the computer system to use in attempting to authenticate the corresponding IoT device.

16. (canceled)

17. The computer system of claim 11, wherein the power-efficiency reference table is indexed at least by unique device identifiers of IoT devices listed in the power-efficiency reference table.

18. The computer system of claim 13, wherein, for each IoT device of the plurality of IoT devices, the power-efficiency reference table further comprises a set of one or more power specifications of the corresponding IoT device.

19. The computer system of claim 11, the operations further comprising engaging in a communication session with the IoT device according to the identified protocol.

20. The computer system of claim 13, the operations further comprising:
receiving an update message pertaining to a given IoT device in the plurality of IoT devices, the update message comprising a second indication of a second cryptographic security protocol, the second cryptographic security protocol being different than a first cryptographic security protocol of which a first indication is currently listed in the power-efficiency reference table in connection with the given IoT device; and
responsively replacing the first indication of the first cryptographic security protocol with the second indication of the second cryptographic security protocol in connection with the given IoT device.

21. One or more non-transitory computer-readable storage media containing instructions that, when executed by at least one hardware processor of a computer system, cause the computer system to perform operations comprising:
receiving, from an Internet of Things (IoT) device, a device-side authentication-initiation message containing a unique device identifier of the IoT device;
using the unique device identifier of IoT device to identify, from a stored power-efficiency reference table, a suitable cryptographic security protocol for the IoT device;
transmitting, to the IoT device, a server-side authentication-initiation message containing an indication of the identified protocol; and
authenticating the IoT device according to the identified protocol.
